(19) United States
(12) Patent Application Publication
(10) Pub. No.: US 2015/0020981 A1
(43) Pub. Date: Jan. 22, 2015

(54) COVERING CURTAIN

(71) Applicant: Macauto Industrial Co., Ltd., Tainan City (TW)

(72) Inventors: Roger Weissmann, Essen (DE); Holger Seel, Wuppertal (DE)

(21) Appl. No.: 14/334,942

(22) Filed: Jul. 18, 2014

(30) Foreign Application Priority Data
Jul. 22, 2013 (DE) 102013012088.8

(51) Int. Cl. B62D 25/12

(52) U.S. Cl. CPC B62D 25/12
USPC 160/273.1

(57) ABSTRACT

The present invention provides a covering curtain to prevent a user's hand from being clipped when using the covering curtain. The covering curtain comprises a fixed end, a free end, an opening, and a covering element. The free end is opposite to the fixed end. The opening is disposed near the free end and comprises a proximal edge and a distal edge, wherein the proximal edge is relatively far from the fixed end and the distal edge is relatively near the fixed end. The covering element is pivotally mounted in the opening and comprises a pivoting bar and a spring element, and the pivoting bar is pivotally mounted to the proximal edge of the opening through the spring element.

### BACKGROUND OF THE INVENTION

1. Field of the Invention

The present invention relates to a covering curtain, especially to a covering curtain that is applied in a motor vehicle.

2. Description of the Prior Art(s)

To cover items placed in an in-vehicle storage space at the backend of a motor vehicle for preventing the items from directly seen through glass of a back door of the motor vehicle, the motor vehicle usually installs a covering curtain in the storage space.

EP0861755B1 and DE20217717U1 disclose a covering curtain for motor vehicles. In EP0861755B1, the covering curtain is installed in the storage space of the motor vehicle and comprises a fixed end, a free end, and a handle portion. The fixed end is mounted to a winding shaft to make the covering curtain extractable and retractable in the storage space. The free end is opposite to the fixed end. The handle portion is arranged on the free end to enable a user to pull out the covering curtain with ease, and the handle portion comprises an opening and a covering element. The opening comprises a distal edge. The distal edge is near the fixed end. The covering element comprises a pivoting bar and a rotating end. The pivoting bar is pivotally mounted to a bottom of the distal edge through a spring element, and the elasticity of the spring element enables the covering element to close the opening and keep the opening in a closed state. The rotating end is opposite to the pivoting bar. The user inserts one hand into the opening to push the covering element and open the opening in an open state, and the user can also extract or retract the covering curtain. When the opening is in the open state, the user's hand is placed in the opening; however, at the same time, the rotating end of the covering element rotates counterclockwise due to the elasticity of the spring element. Hence, the user's hand easily gets clipped by the covering element, causing inconvenience and safety concerns.

In DE20217717U1, the covering curtain, compared to the covering curtain of EP0861755B1, further comprises a brake that can delay the pivotal mechanism of the covering element, allowing the user to remove hands from the opening probably. However, the brake makes the structure of the covering curtain more complicated and increases the cost of the covering curtain. Furthermore, the pivoting bar of the covering element is still pivotally mounted to the distal edge through the spring element; thus, the inconvenient and unsafe problems that the user's hand tends to be clipped by the covering element still cannot be overcome.

To overcome the shortcomings, the present invention provides a covering curtain to mitigate or obviate the aforementioned problems.

### SUMMARY OF THE INVENTION

The objective of the present invention is to prevent a user's hand from clipping while using a covering curtain.

The present invention provides a covering curtain. The covering curtain comprises a fixed end, a free end, an opening, and a covering element.

The free end is opposite to the fixed end.

The opening disposed near the free end and comprises a proximal edge and a distal edge, wherein the proximal edge is relatively far from the fixed end and the distal edge is relatively near the fixed end.

The covering element is pivotally mounted in the opening and comprises a pivoting bar and a spring element, and the pivoting bar is pivotally mounted to the proximal edge of the opening through the spring element, which can prevent the user's hand from clipping while using a covering curtain and improve convenience of using the covering curtain.

Other objectives, advantages and novel features of the invention will become more apparent from the following detailed description when taken in conjunction with the accompanying drawings.

### BRIEF DESCRIPTION OF THE DRAWINGS

FIG. 1 is a schematic perspective view of a covering curtain of the present invention, shown mounted inside of a motor vehicle;

FIG. 2 is a partial side view of the covering curtain in FIG. 1, shown in a closed state; and

FIG. 3 is another partial side view of the covering curtain in FIG. 1, shown in an open state.

### DETAILED DESCRIPTION OF THE PREFERRED EMBODIMENTS

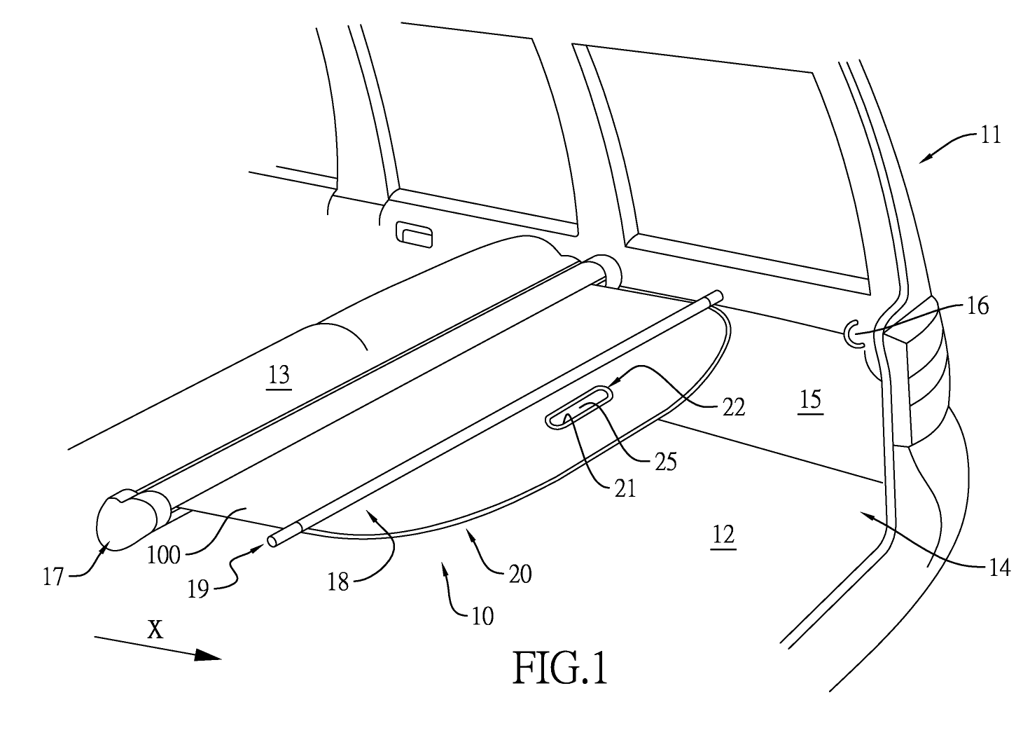

With reference to FIG. 1, a covering curtain 10 in accordance with the present invention is mounted in an inside of a motor vehicle 11. The motor vehicle 11 comprises a storage space 12, a rear seat 13, an entrance 14, two side walls 15, two connecting portions 16, and a winding shaft 17.

The storage space 12 is surrounded by the rear seat 13 and the side walls 15, and communicated with the entrance 14. The rear seat 13 is opposite to the entrance 14. The entrance 14 can be opened or closed through a back door or a tailgate of the motor vehicle 11. The side walls 15 are opposite each other and mounted between the rear seat 13 and the back door or tailgate. The connecting portions 16 are each respectively mounted on the side walls 15 and face the storage space 12. The winding shaft 17 is mounted on the rear seat 13 and is in the storage space 12.

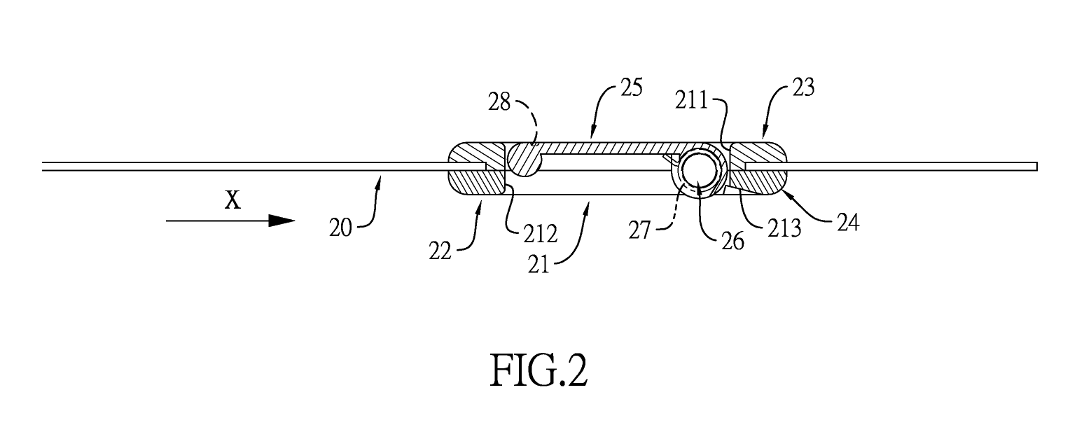

With reference to FIG. 1 and FIG. 2, the covering curtain 10 is connected to the winding shaft 17 and can be pulled out toward the entrance 14 to cover the storage space 12 for shielding function.

The covering curtain 10 comprises a fixed end, a free end 18, an opening 21, and a covering element 25.

The fixed end is connected to the winding shaft 17. The free end 18 is opposite to the fixed end and can be pulled out toward the entrance 14. The opening 21 is disposed near the free end 18 and comprises a proximal edge 211 and a distal edge 212. The proximal edge 211 is relatively near the entrance 14 and the distal edge 212 is relatively near the winding shaft 17. The covering element 25 is pivotally mounted to the opening 21 and comprises a pivoting bar 26 and a spring element 27. The pivoting bar 26 is pivotally mounted to the proximal edge 211 of the opening 21 through the spring element 27. The elasticity of the spring element 27 enables the covering element 25 to close the opening 21 and keeps the opening 21 in a closed state.

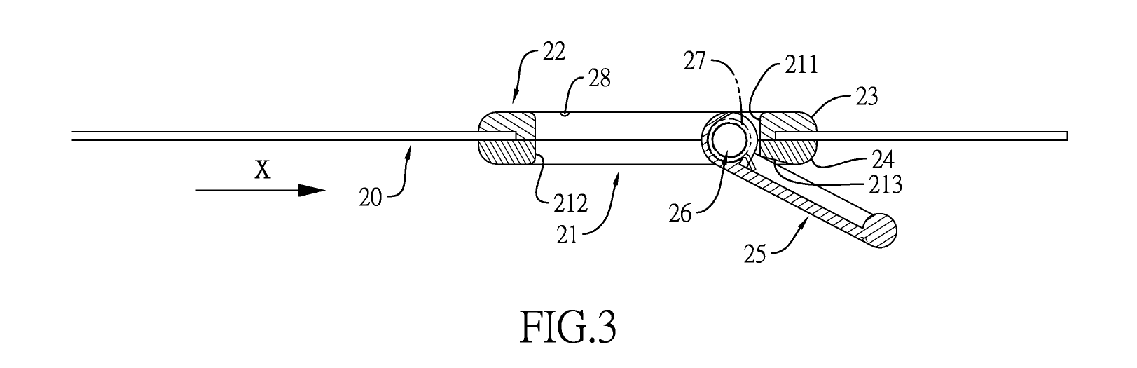

With reference to FIG. 3, when a user puts his/her hand into the opening 21 to push the covering element 25 and open the opening 21 in an open state, and the covering element 25 is pivoted on the pivoting bar 26 and rotates toward a bottom surface of the covering curtain 10 near the free end 18; besides, the user can grasp the covering element 25.

With reference to FIG. 1 and FIG. 2, in a preferable embodiment, the covering curtain 10 comprises a fabric 100, a rod 19, a plate 20, a frame 22, the covering element 25, and a limit portion 28.

The fabric 100 comprises the fixed end and the free end 18, is connected to the winding shaft 17 via the fixed end, and can be winded up in the winding shaft 17 or extended toward the entrance 14.

The rod 19 is mounted to the free end 18 and comprises two ends. The two ends of the rod 19 are each respectively mounted in the two connecting portions 16 of the side walls 15.

The plate 20 is mounted to the rod 19 and can cover a gap between the rod 19 and the back door or tailgate of the motor vehicle 11.

The frame 22 is disposed on the plate 20 and comprises a ring-shaped upper shell 23 and a ring-shaped lower shell 24. The ring-shaped upper shell 23 is mounted on a top surface of the plate 20, and the ring-shaped lower shell 24 is mounted to a bottom surface of the plate 20. The ring-shaped upper and lower shells 23, 24 are combined with each other, and the opening 21 is defined by the ring-shaped upper shell 23 and the ring-shaped lower shell 24 on the plate 20.

The spring element 27 is a torsion spring.

The limit portion 28 is mounted to the ring-shaped upper shell 23 and contacts the covering element 25 to make a top surface of the covering element 25 at the same height with a top surface of the ring-shape upper shell 23 when the opening 21 is in the closed state, which can improve the closing effect of the covering element 25.

With reference to FIG. 2 and FIG. 3, the ring-shaped lower shell 24 comprises an inclined plane 213 formed on a bottom surface of the ring-shape lower shell 24 and near the entrance 14. The inclined plane 213 comprises a proximal side and a distal side. The proximal side is relatively near the covering element 25 and the distal side is relatively far from the covering element 25. Compare to the distal side, the proximal side is relatively near the ring-shaped upper shell 23.

When the opening 21 is in the open state, the covering element 25 is pivoted on the pivoting bar 26 and rotates toward a bottom surface of the inclined plane 213, which shortens the distance between the covering element 25 and the bottom surface of the plate 20, such that the user can easily grasp the covering element 25.

With reference to FIG. 1 and FIG. 3, when the covering curtain 10 is mounted in the motor vehicle 11, the covering curtain 10 is connected to the winding shaft 17, which is mounted to the rear seat 13 and faces to the storage space 12. The user firstly puts his/her hand into the opening 21 to push the covering element 25 to make the covering element 25 rotate counterclockwise toward the bottom surface of the plate 20.

Then the user grasps the covering element 25 and the frame 22, and pulls the covering curtain 10 toward the entrance 14 (as in the x-direction shown in FIG. 1 to FIG. 3).

Finally, the covering curtain 10 is positioned by each end of the rod 19 that is correspondingly mounted in the connecting portion 16 of the side wall 15, such that the covering curtain 10 can cover items placed in the storage space 12.

With reference to FIG. 2 and FIG. 3, when the covering curtain 10 is fixed, the user removes his/her hand from the opening 21 and the covering element 25 returns into the closed state by the elasticity of the spring element 27.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A covering curtain comprising:
a fixed end;
a free end opposite to the fixed end;
an opening disposed near the free end and comprising a proximal edge and a distal edge, wherein the proximal edge is relatively far from the fixed end and the distal edge is relatively near the fixed end; and
a covering element pivotally mounted in the opening and comprising a pivoting bar and a spring element, the pivoting bar pivotally mounted to the proximal edge of the opening through the spring element.

2. The covering curtain as claimed in claim 1, wherein the covering curtain comprises a fabric and a plate;
the fabric comprises the fixed end and the free end;
the plate is mounted to the free end of the fabric;
the opening is arranged on the plate.

3. The covering curtain as claimed in claim 2, wherein the covering curtain comprises a frame disposed on the plate and the opening is defined by the frame.

4. The covering curtain as claimed in claim 3, wherein the spring element is a torsion spring, and the covering curtain comprises a limit portion mounted to the frame.

5. The covering curtain as claimed in claim 4, wherein the frame comprises a ring-shaped upper shell and a ring-shaped lower shell, the ring-shaped upper shell is mounted on a top surface of the plate and the ring-shaped lower shell is mounted on a bottom surface of the plate, and the ring-shaped upper and lower shells are combined with each other, and the opening is defined by the ring-shaped upper shell and the ring-shaped lower shell.

6. The covering curtain as claimed in claim 3, wherein an inclined plane is formed on a bottom surface of the frame and is relatively far from the fixed end.

7. The covering curtain as claimed in claim 4, wherein an inclined plane is formed on a bottom surface of the frame and is relatively far from the fixed end.

8. The covering curtain as claimed in claim 5, wherein an inclined plane is formed on a bottom surface of the ring-shape lower shell and is relatively far from the fixed end.
